(19) United States
(12) Patent Application Publication
(10) Pub. No.: US 2012/0084164 A1
(43) Pub. Date: Apr. 5, 2012

(54) ACCUMULATION ALERTS

(76) Inventors: Ayman Hammad, Pleasanton, CA (US); Francisco Oliva, Redwood City, CA (US); Uzma Makhdumi, Foster City, CA (US); Pat Stan, Pacifica, CA (US); Lori Van Deloo, Los Altos, CA (US); Allen Cueli, Miami Lakes, FL (US)

(21) Appl. No.: 12/895,208

(22) Filed: Sep. 30, 2010

(51) Int. Cl. G06Q 20/00

(52) U.S. Cl. 705/21

(57) ABSTRACT

Systems and methods for defining, observing and detecting transactions that initiate an alert message to be sent to one or more users are disclosed. Aggregate threshold, number of transactions and proximity to reward types of alert messages and alert criteria can be defined or selected by users, merchants, and issuers. Alert messages can be sent based on aggregating transaction data from an observed transaction with information from historical transactions, such as credit card transactions. If the aggregated transaction data associated with the transactions match any of the alert criteria, then alert messages can be sent to one or more users. An alert message may include information from the alert trigger as well as the aggregated transaction data.

### BACKGROUND

Embodiments of the present invention are directed to systems, apparatuses, and methods for providing a consumer with information regarding payment transactions, and more specifically, to a system and method for facilitating a consumer to receive an alert message responsive to a user transaction that, when combined with past transactions over a certain time period, satisfies specific criteria. The present invention is also directed to systems, apparatuses, and methods for enabling a consumer to conduct a payment transaction using a mobile device, and for providing the consumer with an alert message regarding a combination of transactions.

Consumers use payment devices to conduct a variety of different types of transactions, such as for the purchase of goods or services from a merchant or service provider. The payment device may be a debit card, credit card, smart card, or a contactless payment device incorporated into a mobile phone or personal digital assistant (PDA), for example. In some situations, either prior to, during, or after a transaction a consumer may wish to better understand their spending habits during a specific time period. In other situations, the consumer may have specific questions about their purchases involving a particular merchant or type of merchant over the given time period. For example, a consumer may purchase an item at a store and then want to know if their monthly purchases exceed some specified amount, which may have been budgeted to them. Another example might be where a consumer wishes to determine if they are close to any rewards offered by a merchant based on purchases over a period. To illustrate, a local restaurant may offer an awards program that provides a free meal when a consumer purchases five meals in a month. Thus, an alert message that indicates when the consumer is approaching such an award would benefit both the consumer and the merchant restaurant because the alert message reinforces the incentive for the consumer to make additional purchases in order to receive the free meal offered by the reward.

To better understand account activities, consumers typically log onto a web-site associated with the payment device or physically visit a branch store that has access to his or her account. Once the consumer is on the web-site, they may view the account activities of the account and mine data involving transactions within a stated period and the merchant or merchant type, or any other criteria. Such systems may provide facilities for searching for relevant information (e.g., based on date or store location). Yet, the user initiated searches remain substantially inconvenient in that they require the user to manually decide when to run the searches and to interpret the resulting data. Alternatively, consumers may receive alert messages describing transactions involving their accounts in real-time or digests at periodic points in time. However, such messages can inconvenience a user by flooding the user with substantial amounts of information. Thus, the consumer is left to mine and interpret the data to be useful as an alert message.

Although such web-sites and alert messages are effective, improvements could be made. For example, in some instances, consumers may not log onto the website as soon, or comparatively soon, as an account activity has resulted in an interesting event. Thus, there may be some lag time between actually meeting a desired condition and determining that the condition is met on the website. In other cases, consumers may not wish to take the time to mine the website or messages for relevant information (e.g., summing the purchases at a particular store). In the case of alert messages, the consumer may not wish to receive alert messages for every transaction, nor do they wish to organize such account activity in a way that can be easily mined by the user for the relevant information.

A system, apparatus, and method for enabling a consumer to receive an alert message responsive to meeting some condition that involves an aggregation of transactions over a period of time is therefore desired. Embodiments of the present invention address these and other problems, individually and collectively.

### BRIEF SUMMARY

Embodiments of the invention are directed to methods, computer readable medium, servers and systems including alert messages.

In one embodiment, a method for detecting triggering events for initiating alert messages using a notification server is disclosed. The method includes observing a transaction at the notification server and identifying an association with a user account. Transaction data from the observed transaction is then aggregated with transaction data from prior transactions associated with the identified user account. The aggregated transaction data is used to determine if the transaction is a triggering event, based on the comparison, that causes an alert message.

Other related embodiments are directed toward a method for detecting triggering events by determining an accumulated amount spent from the aggregated transaction data and generating an alert message based on determining that the aggregate amount spent exceeds a determinable amount.

Various other embodiments of the present invention are directed toward a method for detecting triggering events by determining a number of transactions from the aggregated transaction data and generating an alert message based on the number of transactions exceeding a determinable number.

Another related embodiment is directed toward a method for detecting triggering events based on the aggregated transaction data including a proximity to a reward and sending an alert message if the aggregated transaction data is within a determinable proximity to a reward of a desired merchant or merchant type.

These and other embodiments of the invention are described in further detail below.

### BRIEF DESCRIPTION OF THE DRAWINGS

FIG. 1 is a schematic diagram of a system 100 that can include and be improved by various embodiments of the present invention.

FIG. 2 is schematic of a system and an associated data flow for setting, defining, storing, and detecting transaction data and alert triggers that can be used for sending user and consumer alert messages according to various embodiments of the present invention.

FIG. 3 shows various types of alert messages and alert criteria and associated data stores according to various embodiments of the present invention.

FIG. 4 shows the data flow and availability of data to an intelligent notification engine according to various embodiments of the present invention.

FIG. 5 is a flow chart of a method for sending alert messages based on aggregating transaction data according to various embodiments of the present invention.

FIGS. 6A and 6B show examples of various types of alert messages according to various embodiments of the present invention.

FIG. 7 shows examples of alert trigger, according to various embodiments of the present invention.

FIG. 8 shows a visual representation of an exemplary number of transaction alert message according to various embodiments of the present invention.

FIG. 9 shows a visual representation of an exemplary proximity to reward alert message according to various embodiments of the present invention.

FIG. 10 is a high-level block diagram of a computer system that may be used to implement various embodiments of the present invention.

### DETAILED DESCRIPTION

Embodiments of the present invention are directed toward systems, methods, alert messages and alert triggers for intelligently providing a user relevant information related to recent transactions. Alert messages can be sent to a user when a triggering event has been detected. For example, a user can be notified by a text message sent to an appropriate mobile phone anytime his or her credit card is used in a transaction that, when combined with other similar transactions conducted within the same time period, exceeds a threshold assigned to a particular merchant or merchant type.

According to various embodiments of the present invention, alert triggers can be classified into at least three categories. For example, alert triggers can be classified or defined under one of the three following general types: “Aggregate Threshold Type,”

“Number of Transaction Type” and “Proximity to Result Type.” Various other miscellaneous transactions, alert messages and triggering events can be implemented with the systems and methods described herein. The bulk of the resulting alert messages, or more simply, alert messages, can be discussed in reference to one or more of the three categories, but on occasion, a user or a user account issuer may find it beneficial to define or specify a triggering event based on transactions that can span multiple categories or the miscellaneous transactions, alert messages and triggering events that do not readily fit into one of the three categories. Embodiments of the present invention can be applied to many different varieties of user accounts, such as credit and debit card accounts, bank accounts, online merchant accounts. Likewise, the systems in which embodiments of the present invention can be used, include, but are not limited to, credit and debit card payment processing networks, financial clearing house systems and other service providers, such as mobile telephone service providers.

The advantages of embodiments of the invention are numerous. Many different types of transactions can be observed by embodiments of the present invention, however, only a select number of transactions will cause an alert message to be generated and sent to a user. As such, embodiments may reduce the number of messages exchanged within systems that provide alert messages to consumers. Further, the alert messages sent by some embodiments are relevant in both content and in time. One specific example is where a consumer defines an alert criteria that will cause an embodiment of the invention to send an alert message if the consumer spends over a hundred dollars at Starbucks® within a given week. Upon determining that a completed transaction puts a consumer over the $100 threshold, some embodiments will not only send the alert message to the consumer in near real-time, but also provide aggregated data associated with the alert criteria (e.g., the amount spent at the specific store). As is explained further below, some other embodiments may aggregate additional transaction data that is not associated with the alert criteria and include such additional aggregated data in the alert message.

Systems

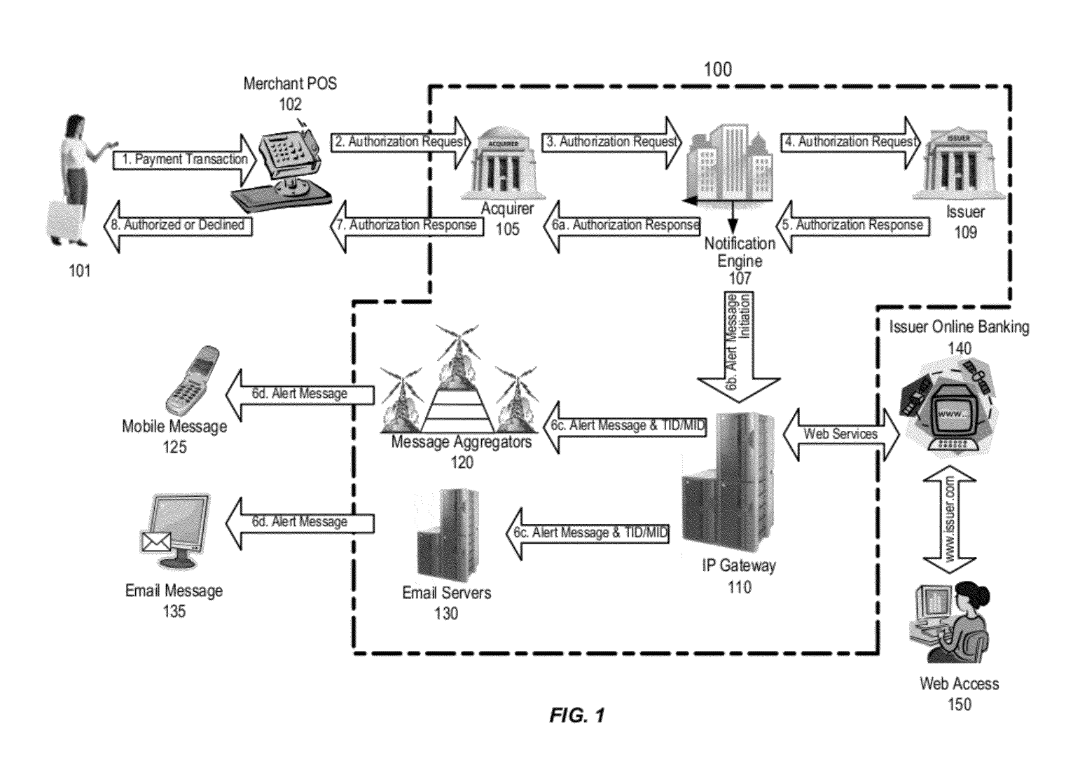

To put various embodiments of the present invention into context, examples of systems in which the various embodiments of alert messages types can be implemented or utilized are described below. The type and configuration of the specific systems that can implement, and thereby be improved, can depend on the goal, function and use of the systems. The exact specifications and operations of such systems can, of course, vary depending on the utility of the systems. The example of the transaction processing system, with alert messaging capability, described in reference to FIG. 1 is intended to be illustrative and should not be construed to limit embodiments of the present invention.

FIG. 1 is a schematic diagram of a system 100, which can include and be improved by various embodiments of the present invention. In some embodiments, system 100 can include a transaction processing system that can use and/or process many forms of portable consumer devices or user tokens, user account number and identifiers to initiate various forms of transactions including, but not limited to, credit card transactions, debit card transactions, mobile telephone initiated transactions such as telephone calls, etc. In other embodiments, users can initiate transactions from a computer either by logging into an authorized website that has the ability to initiate a transaction from particular account, i.e. PayPal™, Google Checkout™ or the like, or by a user entering account information from personal memory for a “token-not-present” transaction. When a transaction is initiated, embodiments of the present invention may receive transaction data, which can include the date, time, location, origin, amount, personal identification number (PIN), number of transactions or purchases, requested or final result and any other information that can be sent along with or inferred from the transaction for purposes of initiating, routing, processing or reconciling the transaction. Regardless of the method in which the transaction from a particular account is initiated or the specific transaction data received, various embodiments of the present invention can be used to receive transaction data and initiate, aggregate transaction data and send alert messages to one or more user using various communication channels.

The transaction processing system 100 is an example of a system that can be used to process user transactions and then selectively sends an alert message to one or more users based on transaction data. User 101 can initiate a transaction or other account activity, such as a credit card transaction in step 1. The transaction can be initiated with a point-of-sale (POS) terminal 102 (POS terminal 102 is an example of an access device), such as a credit card terminal, a computer, a PDA or a mobile telephone. The transaction can be initiated by presenting a portable consumer device to POS terminal. Some POS terminals are configured to read information from the portable consumer device with contact or contactless detection devices. Once the transaction is initiated, an authorization request message can be sent to an entity holding or maintaining the payee or payer user accounts or both, such as an acquirer 105 in step 2. In some embodiments, acquirer 105 can reformat the authorization request message into its own authorization request message and send the message to a notification engine 107 in step 3.

In other embodiments, acquirer 105 can simply pass on the authorization request message it receives from the POS terminal 102 in step 2. Notification engine 107 can pass on the authorization request message from acquirer 105 and POS terminal 102 to issuer 109 for further authorization and authentication in step 4. Once issuer 109 authenticates or authorizes the transaction or other activity requested in the authorization request message, issuer 109 can send an authorization response to the notification engine 107 in step 5. Once notification engine 107 receives the authorization response message, the process can be bifurcated. In step 6a, notification engine 107 can send an authorization response message to acquirer 105, which in turn can provide an authorization response message to the POS terminal 102 in step 7. In step 8, POS terminal 102 can then inform user 101 or a merchant as to whether the requested transaction or other activity is authorized or declined based on the authorization response message.

Meanwhile, in step 6b, notification engine 107 can send an alert message initiation request to communication/IP gateway, such as Internet Protocol Gateway 110. Internet Protocol Gateway 110 can use the alert message request from the notification engine 107 to generate an alert message. In some embodiments, Internet Protocol Gateway 110 can parse out a transaction identifier or a message identifier from the alert message request. In other embodiments, Internet Protocol Gateway 110 can generate a transaction or message identifier. In either case, Internet Protocol Gateway 110 can associate each alert message generated with an identifier.

Internet Protocol Gateway 110 can then route the alert message and the associated identifier to one or more message aggregators 120 or e-mail servers 130 in step 6c. The message aggregator to which the alert message and the identifier are sent can be based on information contained an alert message settings file or in the alert message initiation request and information regarding the message aggregators contained in a routing table. For example, the alert message initiation request, which can be based on a set of user or issuer defined settings, can request that an alert message be sent out via a Simple Message Service (SMS) protocol, Multimedia Messaging Service (MMS) protocol, e-mail or any other messaging service suitable for delivering high-volume messages quickly, efficiently and reliably. Embodiments in which the alert message initiation request specifies a specific delivery protocol, the

Internet Protocol Gateway 110 can refer to a routing table to determine which message aggregator offers the appropriate delivery protocol. Additionally, the Internet Protocol Gateway 110 can refer to the routing table to determine other pertinent characteristics and information regarding each available message aggregator or mobile carrier 120 or e-mail server 130.

Embodiments in which message aggregators 120 can route alert messages to one or more mobile communications service providers, such as mobile telephone service providers, message aggregators 120 can format the messages as one or more text, SMS, MMS or other mobile device compatible messages. At step 6d, the mobile communication carriers can send the mobile compatible messages to one or more mobile devices associated with user 101, a business or a representative of the business. In some embodiments, the mobile device 125 can be a cellular telephone, smart phone, a pager, a two-way-pager or other mobile user device suitable for receiving wireless messages.

In other embodiments, Internet Protocol Gateway 110 can route the alert message and MID to e-mail servers 130 in step 6c. In such embodiments, e-mail servers 130 can then route an e-mail message to an e-mail compatible device 135. E-mail compatible device 135 can be a personal computer, a laptop computer, desktop computer, a tablet computer, a smart phone, an e-mail capable mobile telephone or any other e-mail device capable of receiving e-mail.

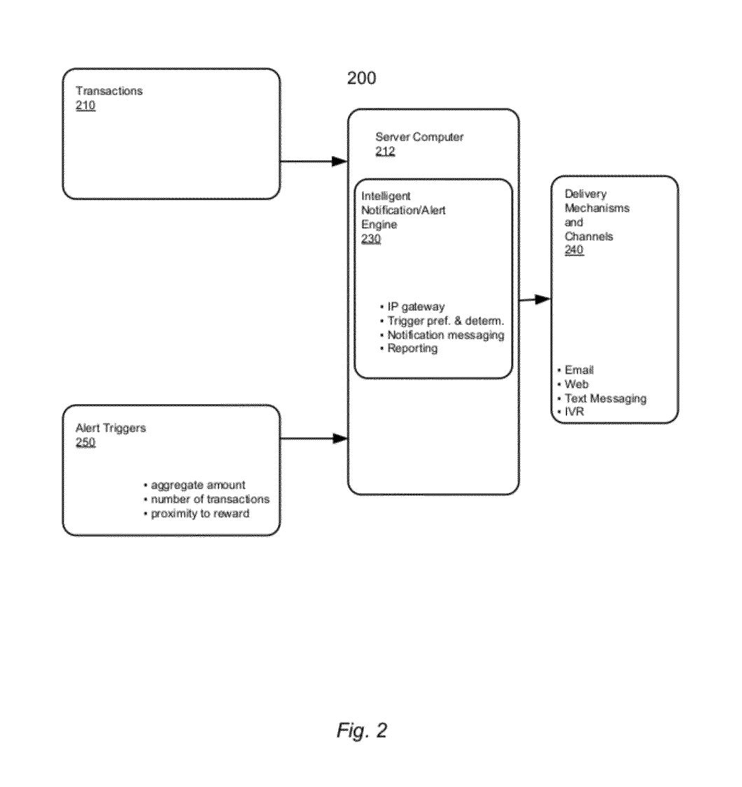

FIG. 2 is a schematic of a system 200 and an associated data flow for setting, defining, storing and detecting transactions and alert triggers that can be triggered to initiate and send alert messages according to various embodiments of the present invention. Notification engine 107 in FIG. 1 can include an intelligent notification engine 230 of FIG. 2. Due to the position of the intelligent notification engine 230 in system 100, it can observe and detect any transaction amongst merchant POS 102, acquirer 105 and issuer 109. Intelligent notification engine 230 can be configured to check and compare all transactions or other transactions it observes, transmits, translates, reformats and/or otherwise has access to. Intelligent notification engine 230 can be implemented as software or a software module in a computer or a server computer 212.

As used herein, the terms “user accounts” and “transaction” have very broad meaning and can include various types of user accounts and user account activities without deviating from the spirit or scope of the present invention. For example, a user account can include a credit card account, a debit card account, a checking account, a savings account, a mobile telephone account, an e-mail account, an online merchants or payment processing accounts, or any other account. Similarly, a transaction can include, but is not limited to, financial transactions, such as credit card transactions, debit card transactions, cash back transactions or any other activity associated with or involving one or more of the exemplary user accounts listed above.

Intelligent notification engine 230 can request and/or receive information regarding transactions 210. Intelligent notification engine 230 can observe transactions 210 in the form of user account transactions or activity, user account status updates, user account settings or preference changes, or whenever an issuer of the user account would like to push or send information, i.e. advertisements and/or reward opportunities, to one or more of the users. Transactions 210 can include all transaction data regarding the information, status, changes and activity associated or involving a particular user account. For example, transaction data can include the date, time, location, origin, amount, personal identification number (PIN), number of transactions or purchases, requested or final result and any other information that can be sent along with or inferred from the transaction for purposes of initiating, routing, processing or reconciling the transaction. In other embodiments, transactions 210 can include information regarding multiple accounts for one or more related consumers or users.

Intelligent notification engine 230 can compare information contained in the transactions 210 against one or more alert triggers to make a determination as to whether a particular observed transaction triggers or otherwise initiates an alert message. Transactions that trigger or otherwise initiate an alert message may also be referred to as triggering events. Alert triggers can be defined by an issuer, an acquirer, merchant, a user associated with the user account, or any other entity. The definition of the alert trigger can be stored within a data store within the intelligent notification engine 230 or they can be stored in a remote data store accessible to the intelligent notification engine 230. In some embodiments, a user, issuer, acquirer, merchant or any other entity may define alert criteria of the alert trigger. Alert criteria are parameters of the alert trigger that are compared with transaction data to determine if an alert message is to be sent. Intelligent notification engine 230 can, either in real-time or in a batch basis, compare transaction data for transactions 210 for a particular user account with the stored alert criteria of an alert trigger to initiate the alert message.

When the intelligent notification engine 230 determines that transaction data triggers an alert trigger, as will be further described below, the alert message can then be sent to a user via various delivery mechanisms and channels 240. Once an alert message initiation request is sent to delivery mechanisms and channels 240, the alert message can be sent to one or more users via one or more delivery channels such as, e-mail, the World Wide Web, or text messages to portable consumer devices such as mobile telephones, pagers, etc.

As will be described in greater detail below, transaction data for individual transactions may be combined with historical transactions to form aggregated transaction data, which is then evaluated against the alert criteria. Consequently, such alert triggers and criteria are not evaluating information related to single transactions. Instead, the alert triggers and criteria are evaluating information related to a combination of transactions associated with the particular user account, thereby providing a single message that is relevant to many transactions.

Alert Message and Alert Criteria Types

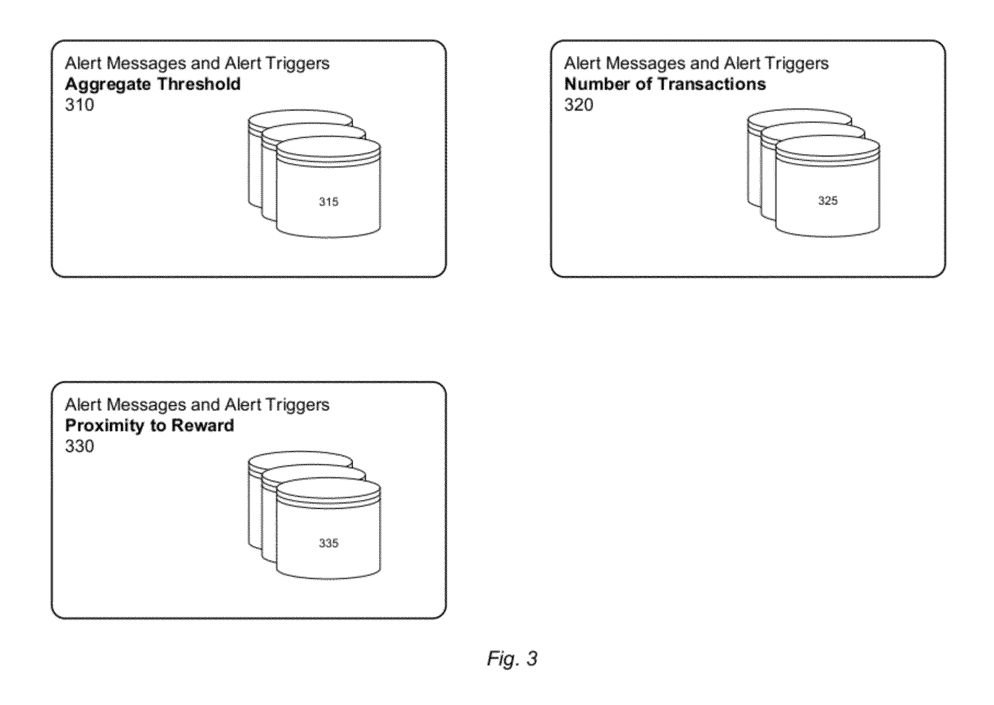

FIG. 3 shows various categories of alert messages and alert criteria types and associated data stores according to various embodiments of the present invention. As used herein, the terms “alert trigger definition types” and “alert criteria types” can be used interchangeably to refer to various categories of criteria or determinations for triggering events. FIG. 3 shows three specific, though not necessarily mutually exclusive, types of alert messages and alert criteria.

Various embodiments include alert messages and associated alert criteria such as aggregate threshold type 310, number of transactions type 320 and proximity to reward type 330 shown in FIG. 3. Each type of alert messages and associated criteria can be stored in a memory or data store such as databases 315, 325 and 335, all of which are accessible to intelligent notification engine 230. In some embodiments the databases 315, 325 and 335 are internal to and included in intelligent notification engine 230. In other embodiments, the databases can be remotely accessible to intelligent notification engine 230 via any network suitable for quick and secure data transfers.

Aggregate threshold type 310 can include definitions of alert messages and alert criteria that list threshold amounts that intelligent notification engine 230 can use to determine if the accumulated amount spent at a merchant and/or merchant type exceeds the defined threshold. In some embodiments the intelligent notification engine 230 may analyze transactions associated with the consumer to calculate the accumulated amount. That is, the intelligent notification engine 230 may generate an accumulation number based on looking up transaction records stored in the transactions 210. In other embodiments, the intelligent notification engine 230 may store, access and/or otherwise maintain a running counter that is updated as the intelligent notification engine 230 receives notification of transactions involving a particular account number or consumer. Specific exemplary alert messages and alert criteria will be discussed below in more detail.

Number of transactions type 320 can include definitions of alert messages and alert criteria that list number of transactions with a specific merchant or merchant that intelligent notification engine 230 can use to determine if the user has made or exceeded a certain number of purchases. Similar to the aggregate threshold type 310, the intelligent notification engine 230 may determine the number of transaction type 320 by accessing transaction records stored in or derived from the transactions 210 or by storing and accessing a running counter.

Proximity to reward type alert messages and alert criteria 330 can include definitions of alert criteria that can include a measure of how close a user is to receiving a reward (e.g., as may be offered by a merchant or issuer). For example, an alert message can be triggered based on the intelligent notification engine 230 determining that the consumer is a single transaction away from receiving coupons or reward points from a merchant or issuer. Similarly, the alert message can be triggered by a particular item, product or service being placed in an online shopping basket or included in a particular transaction or user account event. Specifically, such alert criteria can be based on SKU or UPC identifiers being present, related to or associated with a particular transaction.

Method of Detecting Triggering Events and Initiating Alert Messages

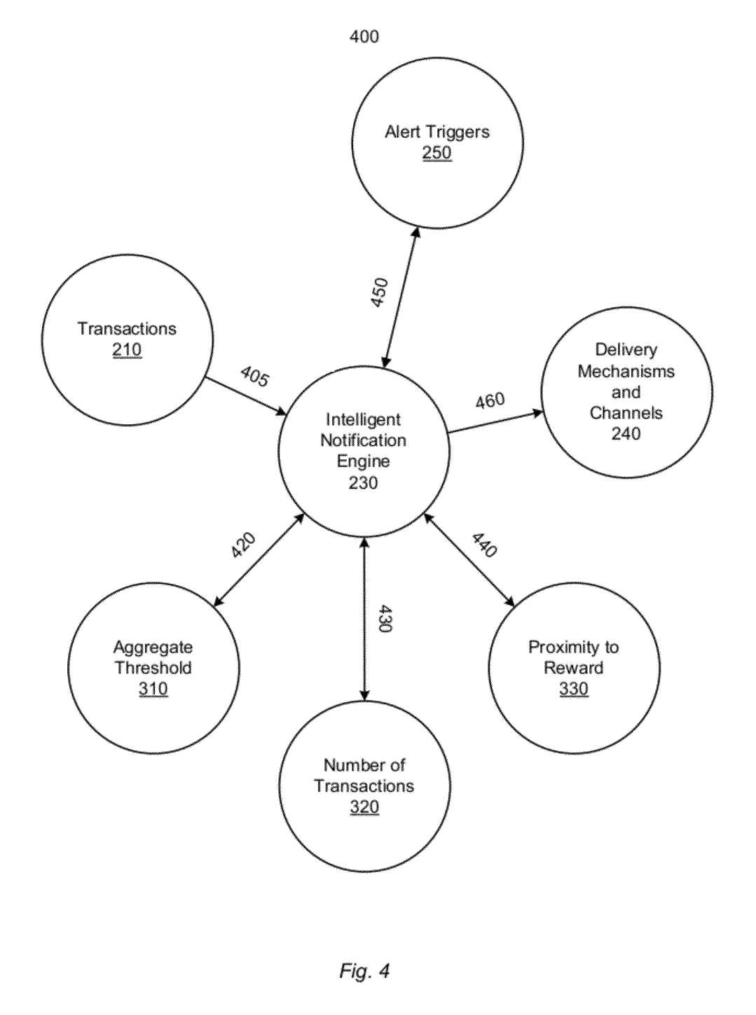

FIG. 4 shows the data to and availability of data to intelligent notification engine 230 according to various embodiments of the present invention. Intelligent notification engine 230 can be implemented as software or a software module in a computer or a server computer in or connected to a system like the one shown in FIG. 1. In alternative embodiments, intelligent notification engine 230 can be implemented as a service provided by a third party provider external to a system like system 100 in FIG. 1. In such embodiments, transaction data can be filtered or redacted before being sent to the intelligent notification engine 230 so as to protect users' private information and secure transactions.

As shown, intelligent notification engine 230 can be communicatively connected to various systems, server computers, data stores and computer readable media via any wired or wireless network suitable for conducting secure and efficient electronic data communication. In some embodiments, all or some of the electronic communication over connections 405, 420, 430, 440,450 and 460 between intelligent notification engine 230 and the other components shown can be encrypted or otherwise secured to protect the data transmissions from being intercepted by unintended recipients, such as potential fraudsters.

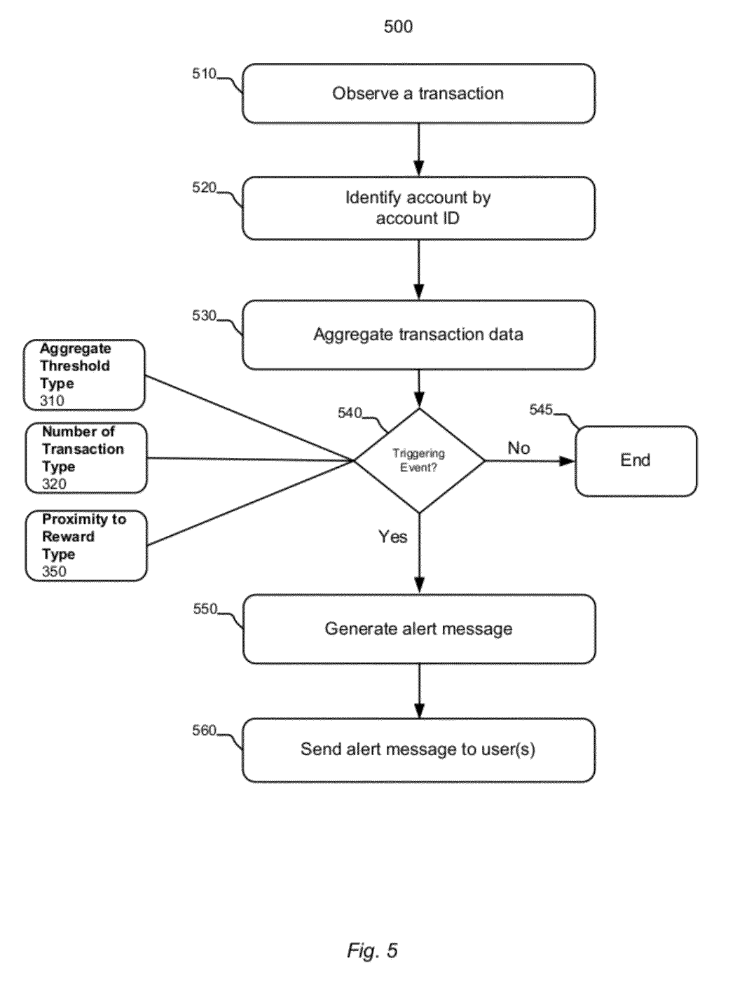

FIG. 5 is a flow chart of a method for sending alert messages based on transactions according to various embodiments of the present invention. The flowchart shown in FIG. 5 is discussed with reference to FIG. 4 and the components and the connections shown therein.

In step 510, the intelligent notification engine 230 can observe a transaction. As previously discussed, a transaction can include various user account activities such as financial transactions conducted with a credit or debit card as well as activity involving online or mobile communication device accounts. To observe a transaction, the intelligent notification engine 230 can use transaction data it receives either intentionally or incidentally from merchant POS 102, acquirer 105, issuer 109 or other user account event processing computer or computer server as part of the transaction processing procedure or protocol.

Alternatively, the transaction data can be sent to the intelligent notification engine 230 in processes external to the transaction processing procedure. In either case, observing transaction data can include intelligent notification engine 230 receiving and parsing information data associated with the observed transaction. As described above, transaction data can include the date, time, location, origin, amount, personal identification number (PIN), number of transactions or purchases, requested or final result and any other information that can be sent along with or inferred from the transaction for purposes of initiating, routing, processing or reconciling the transaction.

With the transaction data, the intelligent notification engine 230 can parse a user account identifier associated with the transaction. Using the user account identifier, such as a user account number or user account name, the intelligent notification engine 230 can identify a user account in step 520. Using the user account identifier, the intelligent notification engine 230 can retrieve historical transaction data in step 530 and aggregate the transaction data of the observed transaction with transaction data in the historical transactions. As a specific example, the intelligent notification engine 230 may aggregate an amount spent at a specific merchant within a specified time period (as the intelligent notification engine 230 may perform in processing an aggregate threshold type, described below). Accordingly, in some embodiments, the selection of what information to aggregate may depend on the alert triggers or alert criteria associated with the user account, which may be accessed based an association with the user account identifier.

In various embodiments, the prior or historical transaction data and alert triggers can be stored and received from data stores established and maintained by the transaction processing network 100, like the one shown in FIG. 1. In other embodiments, the prior transactions can be stored in a data store established or maintained by the intelligent notification engine 230.

In step 540, intelligent notification engine 230 can compare the aggregated transaction data with alert criteria of an alert trigger to determine if the condition associated with the alert trigger is met. In some embodiments, the type of alert trigger or alert criteria against which the aggregated transaction data is compared can be based on which type of alert triggers or alert criteria are designated for or associated with the user account involved with the observed transaction data.

Aggregate threshold type 310, number of transaction type 320 and proximity to reward type 330 alert criteria can be referenced by intelligent notification engine 230 to compare with the aggregated transaction data generated from the observed transaction data and historical transaction data. The intelligent notification engine 230 can compare the aggregated transaction data with the various types of alert criteria and, if the aggregated transaction data does not match or otherwise qualify as a triggering event under one or more of the alert criteria, then an alert message is not initiated nor sent and the process ends at step 545.

However, if the aggregated transaction data matches or otherwise qualifies as a triggering event under one or more of the alert criteria, then intelligent notification engine 230 can then generate an alert message that includes the aggregated transaction data and the alert trigger at step 550. In some example embodiments, intelligent notification engine 230 can check via connections 420, 430, 440, 450 and 460 of each or some of the alert criteria types to determine what kind of alert message, if any, should be sent to a user and how. In some embodiments, the intelligent notification engine 230 can determine not to send an alert message and only log the observed user event for later reference.

When an alert message is generated, the intelligent notification engine 230 can send the alert message via the appropriate delivery method and channel in step 560.

Alert Message Delivery Channels

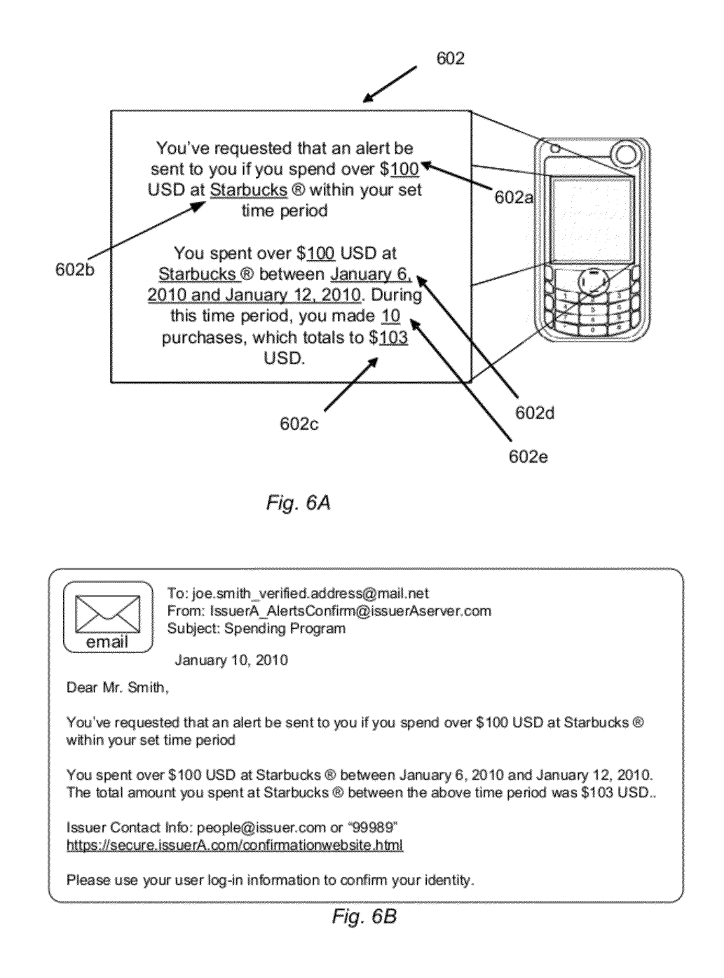

FIGS. 6A and 6B show examples of various types of alert messages and delivery channels according to various embodiments of the present invention. The method and channel of delivery can depend on numerous factors. The most relevant factor can be user preference. Providing expedient and useful alert messages is helpful to users when it is delivered by their method of choice. When users know through which channels to expect alert messages, they can be better prepared to be monitor that channel for timely alert messages. For example, while some users may prefer to receive alert messages on their mobile telephone via an SMS message 602, like the one shown in FIG. 6A, to receive non-intrusive, yet timely messages, other users may not have adopted text messaging on their mobile telephones. Such users would not find it helpful, and in some case could actually find it annoying, to receive an alert message via SMS messaging if they are not accustomed receiving such messages. In such cases, delivering an alert message via another channel, such as email (e.g., see FIG. 6B), automated telephone call or traditional post, might be preferable.

In certain embodiments of the present invention, the alert message may contain information describing the sender, such as the contact information of the sender (see 604a of FIG. 6B), logo of the sender or other identifying information. Although not shown, an alert message may also include account information to identify the account involved in the transaction. The account information can clearly identify the account in the alert message, but it may not include the full and complete account number in order to protect the information should the alert message ever get lost or intercepted. For example, an alert message may use a phrase “Credit Card 72” to identify a credit card account that ends in 72. The sender information, the logo, and the account information help the user to recognize the account involved in the transaction quickly.

In certain embodiments of the invention, the main body or content of an alert message may comprise various data, including data related to the alert trigger information (e.g., 602a, 602b and 602d). The alert trigger information can be any information describing the alert trigger and associated alert criteria that was triggered to cause the alert message sent. Exemplary alert trigger information may read as follows: “You've requested that a report be sent to you if you spend over $100 dollars USD at Starbucks® within your set time period.” Alert trigger information may also include an indication of the relevant time period, such as “between Jan. 6, 2010 and Jan. 12, 2010.” See FIG. 6A, reference 602d.

The alert message may also include the aggregated transaction data (e.g., 602e and 602c). Aggregated transaction data can be the aggregation or accumulation of particular transaction data. A specific example of an aggregated transaction data is the accumulation of amounts spent in transactions with a particular merchant. Aggregated transaction data can be examined against or associated with alert criteria of an alert trigger to initiate or otherwise cause an alert message to be sent. For example, in the case of an aggregate threshold type that causes an alert message if over a hundred dollars is spent at a store in the given period, the aggregated transaction data may include the accumulated amount spent 602c at the specific merchant. The aggregated transaction data may also include transaction data that is aggregated or otherwise accumulated but not compared against or otherwise associated with the alert criteria. Continuing the aggregated threshold type, the aggregated transaction data can also include a total number of purchases 602e that make up the total amount spent 602c. In this way, the aggregated transaction data includes information not specified by the alert trigger but still useful to the user in understanding the reason for being notified by a payment system. Because the intelligent notification engine 230 sends out alert messages based on aggregated transaction data, the user is not repeatedly receiving information on each transaction, nor does the user need to filter out irrelevant information, such as transactions outside of the time period that is of interest.

FIG. 6A shows an example of an alert message than can be sent to one or more users' communications devices. The communications devices can include, but are not limited to, cellular or mobile telephones, smart phones, pagers or any other device capable of receiving/sending short alphanumeric text messages such SMS or MMS based text messaging services. Sometimes, communication devices may also be portable consumer devices (e.g., when a phone is both used to receive alert messages and can also be used to make payments). In other embodiments, communications devices can be separate from portable consumer devices (e.g., when a phone is used to receive alert messages and payment cards are used to make payments). As shown, the text message can include alert trigger information and aggregated transaction data.

FIG. 6B shows an example of an alert message that can be sent one or more users via email or other internet/intranet based message delivery system, such as instant messaging. The email message can include information similar to the information provided in the text message based alert message discussed above in reference to FIG. 6A. Furthermore, the email alert message can also include hyperlinks that the receiving user can follow to respond to the alert message. In some embodiments, the text message based alert messages can also include hyperlink information, as more users, manufacturers and service providers of mobile communication devices are currently adopting high-speed wireless internet access for such devices.

In embodiments of the invention, alert messages may be sent substantially contemporaneously with the initiation of a transaction. For example, in some embodiments, the alert messages are sent within about 1, 5, 10, and 20 minutes after a person initiates a transaction with his portable consumer device (e.g., after he swipes his card in a POS terminal at a merchant).

In some embodiments of the invention, the intelligent notification engine may also send a user an audio file associated with an alert message along with the alert message. A mobile communication device receiving the alert message plays the audio file when the alert message is received. The notification engine can send variable audio files based on the transaction, such as the value of the transaction, the type of the transaction, the location of the transaction, and the type of the store, etc. For instance, an audio file of loud alarm sound may be sent when a combination of transactions in the current time period exceeds a threshold amount.

Transactions, Triggering Events and Alert Triggers

Transactions can include a variety activities involving various user accounts including, but not limited to, credit card transactions, debit card transactions, cash back transactions, etc. Any user account activity associated with one or more user accounts and observable by the intelligent notification engine 230 or other system can be a user account event.

In some example embodiments, transactions can include virtual transactions. Virtual transactions may represent financial transactions that are not processed by the transaction processing network 100, as shown in FIG. 1. An example of a virtual transaction may include an item being placed in a digital or software-based shopping cart, similar to those found in e-commerce websites or applications. Placing an item in a shopping cart does not involve a financial transaction. However, in some embodiments, it may be useful for a consumer to receive an alert message before a product is purchased. Such may be the case when the consumer may exceed his or her budgeted amount for a particular merchant or merchant type for the month if the consumer proceeds and purchases the carted item on a website. Additionally, virtual transactions may be submitted by a web interface or software interface. For example, to create a more complete history of transactions, a consumer may create a virtual transaction to represent a cash transaction, which may not be observed by system 100. The consumer may create such a virtual transaction via the web access 150, as shown in FIG. 1, or any other suitable access.

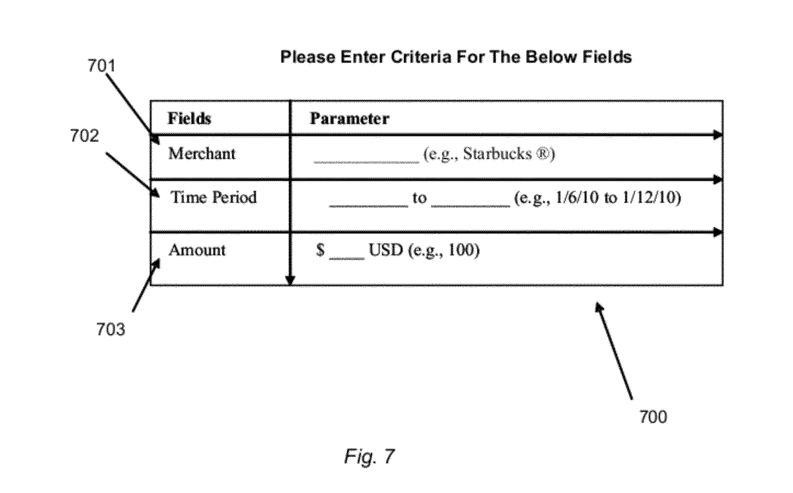

Whether a transaction initiates an alert message depends on whether it qualifies as a triggering event. If the observed transaction qualifies as a triggering event, the intelligent notification engine 230 can then initiate an alert message request to Internet Protocol Gateway gateway 110 or can send the alert message on its own behalf. Qualifying as a triggering event is based on definitions of alert triggers and alert criteria. To illustrate, FIG. 7 is a diagram that shows structure of a definition of an alert trigger, according to an example embodiment. As shown, a alert trigger 700 can specify various parameters or alert criteria, as may be selected by a user, such as threshold values (703) spent at a specific merchant (701) over a time period (702), such as a range of dates or various frequencies of time (e.g., daily, weekly, monthly, or any other period). The specific alert criteria included in an alert trigger depend on the type of the alert trigger.

Specific embodiments of alert triggers and criteria will be illustrated using specific examples, discussed below.

Alert Messages and Alert Trigger Types

Aggregate Threshold Type

FIGS. 6A and 6B, as introduced above, show examples of aggregate threshold alert messages, according to various embodiments of the present invention. Aggregate threshold alert messages can be related to the total amount spent during a given time period at a specific merchant or merchant type. As shown, an alert message can be sent to one or more users when the intelligent notification engine 230 determines that the user account associated with a particular transaction has exceeded a threshold amount at particular merchant or merchant type. In this way, the intelligent notification engine 230 does not simply consider a single transaction in isolation but rather aggregates specific transaction data (e.g., amount spent) among various transactions to determine whether an alert message is to be sent to the user. Further, the intelligent notification engine 230 may include further aggregated transaction data in the alert message. Further aggregated transaction data may be aggregation data not directly used in the determination of whether a transaction qualifies as a triggering event. A specific example of further aggregated transaction data is a number of purchases (see 602e) that make up the accumulated amount spent. In the case of the number of purchases, the intelligent notification engine 230 sends the alert message to the user independent of any consideration for the number of transactions. However, the intelligent notification engine 230 may include such information because it provides a comparatively complete picture of the periodic spending. Having such information allows the user to make useful interpretations of the report, such as determining that exceeding the threshold amount was based on a fraudulent purchase or that exceeding the threshold amount was due to underestimating the number or purchases needed for the specified period.

In some example embodiments, the aggregated threshold alert message may further include details of the historical transactions that the intelligent notification engine 230 uses to calculate the aggregate information. For example, although not shown, alert message 602 may show information regarding each of the ten transactions at Starbucks® that total $103. For example, the alert message 602 may list specific transaction data, such as transaction amounts, time, and location data of each transaction occurring during the period. Providing such information provides the consumer greater level of detail while, at the same time, limits the data to relevant information that may be of interest to the consumer.

Number of Transaction Type

Alert messages can be sent when a user enters a specified number of transactions with a particular merchant or merchant type over a period of time. In various embodiments, a transaction may be based per item (e.g., a sku or individual item) or based on a payment request (e.g., for each card swipe).

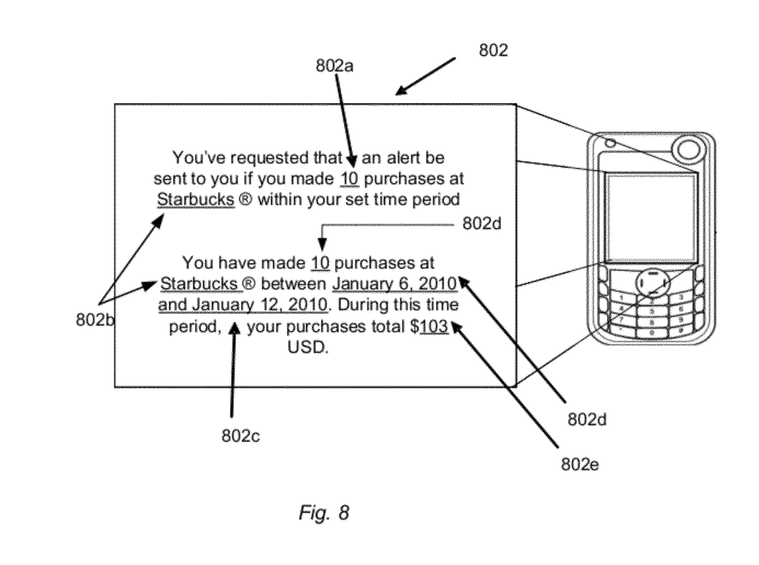

FIG. 8 shows a specific example of an alert message 800 that is a number of transaction type. The alert message 800 can be sent upon the intelligent notification engine 230 observing a transaction, aggregating information from the transaction (e.g., the number of transactions involved in the transaction) with information from past transactions (e.g., the number of transactions involved in the past during the same period), and determining that the transaction is a triggering event based on a number of transaction alert trigger (e.g., that the accumulated number of transactions exceeds an amount set by the user). In some example embodiments, the intelligent notification engine 230 may keep a running count of the number of transactions that satisfy a criteria set. The criteria set may include an identifier associated with a specific merchant or merchant type. In other example embodiments, the criteria set may include a transaction type, such as money transfer, or result of transaction, such as an authorization rejection. The intelligent notification engine 230 can calculate the number of transactions responsive to receiving a transaction or upon periodic or specified times.

Similar to the aggregate threshold status report described above, the number of transaction alert message may provide alert trigger information (e.g., 802a-c) as well as aggregated transaction data (e.g., 802d-e). In particular, the alert message 802 indicates that the user previously defined an alert trigger and corresponding alert criteria that would cause the report to be sent if the user made ten purchases at Starbucks®. In this example, the user made ten purchases, which is indicated as aggregated transaction data 802d. Additionally, the alert message includes further aggregated transaction data 802e, which indicates the total amount spent in those ten purchases, even though such aggregated transaction data is independent of the sending of the alert message.

In some example embodiments, the number of transaction alert message may further include details of the historical transactions that the intelligent notification engine 230 uses to calculate the aggregated transaction data. For example, although not shown, alert message 802 may show information regarding the ten transactions at Starbucks® that total $103. Providing such information provides the consumer greater level of detail while, at the same time, limits the data to relevant information that may be of interest to the consumer.

Proximity to Reward Type

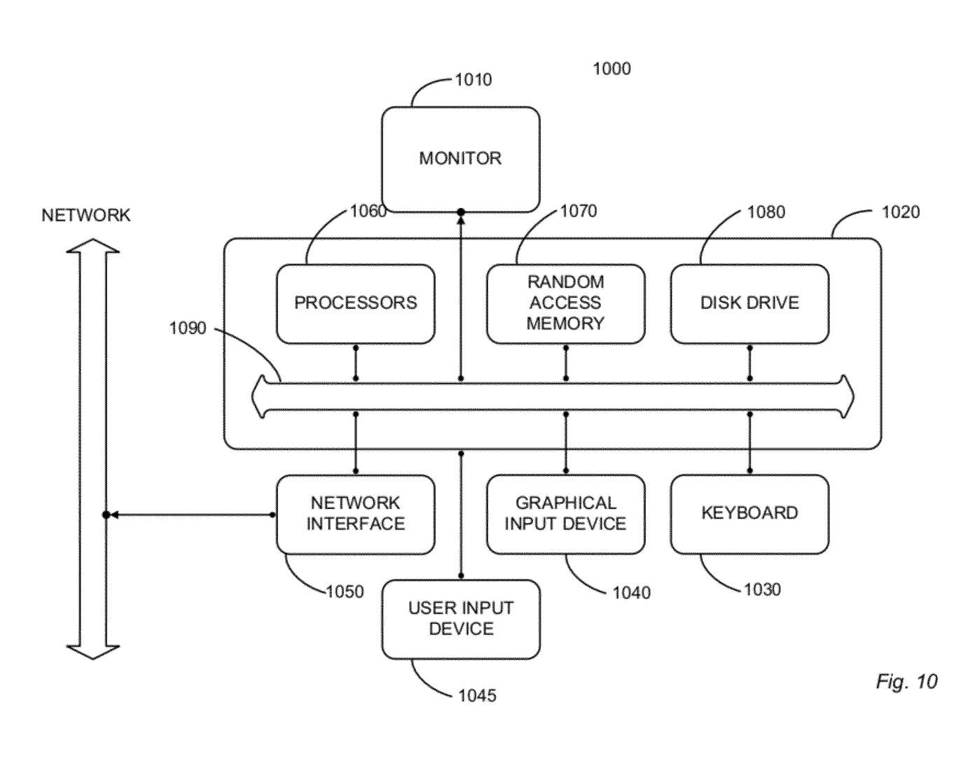

FIG. 10 shows an example of proximity to reward type alert message, according to various embodiments of the present invention. The proximity to reward type alert message can, in some instances, provide the user relevant information that is usable to decide whether to enter further transactions. A user may want to enter additional transactions with a merchant in order to receive a reward offered by a merchant, for example. Besides benefiting the user, sending proximity to reward type alert messages to consumer may also be of value to merchants because such reports may incentivize consumers to make further purchases with the merchant.

For example, in some example embodiments, the intelligent notification engine 230 may receive alert criteria for a proximity to rewards alert trigger from both a merchant or an issuer and a consumer associated with an account. Each individual set of alert criteria may only partially define or provide the alert criteria of the alert trigger that is used to generate proximity to reward alert messages. In such a case, the intelligent notification engine 230 may combine the alert criteria of each of the alert triggers to create a single alert criteria that results in proximity to reward type status reports.

To illustrate, the intelligent notification engine 230 may receive an alert criteria from a user associated with a credit card account. This alert criteria may indicate that the user is interested in receiving alert messages whenever he or she is within a single purchase from earning a reward from Starbucks®. In example embodiments, the alert criteria received from the user may include parameters that identify the user account, the merchant of interest (e.g., a merchant code linked to Starbucks®) and the proximity amount (e.g., a number of purchases, number of transactions or a currency amount). In other example embodiments, the alert criteria may also indicate that it is a “proximity to reward” type. In yet other example embodiments, the alert criteria may indicate that the user of the account is broadly interested in a merchant type, say retailer, food or gas.

At some time prior to, during, or after the user submits this alert trigger, Starbucks® may create a rewards program that gives a consumer a coupon for $10 if the user makes 5 purchases in a given month. Starbucks® may represent this rewards program by submitting an alert criteria to the intelligent notification engine 230. An example of such alert criteria may be a message that indicates the merchant or merchant type (e.g., using a merchant code) and a condition precedent. A condition precedent can indicate the condition that needs to be satisfied before the reward is given to the user. A specific example of a condition precedent is a number of transactions, such as 5, 10 or any other number. Other examples of condition precedents may include a total amount spent during the given time period or any other transaction.

Upon receiving alert criteria from the user and the merchant and determining that the user is interested in receiving rewards offered by the merchant, the intelligent notification engine 230 may generate a combined alert criteria that may initiate or otherwise cause an alert message to be sent to the user if the user reaches a proximity of obtaining the reward offered by the merchant, as may be determined based on a function of the proximity defined in the alert criteria of the user and the condition precedent of the alert criteria of the merchant. For example, if the user defines a proximity of “1 transaction” and the merchant defines a condition precedent of “5 purchases,” the intelligent notification engine 230 can send the user an alert message upon aggregating transaction data from transactions to determine that the user has made four purchases.

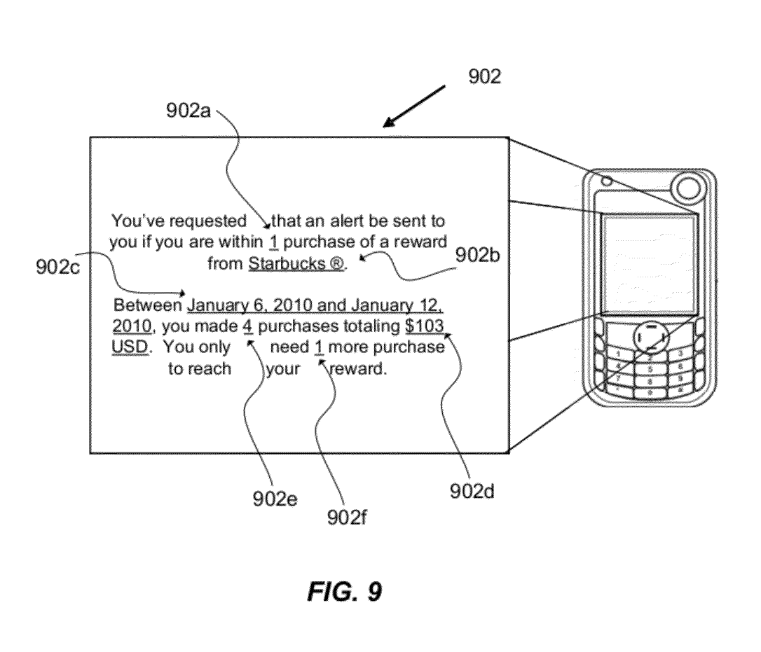

FIG. 9 shows a diagram of an example of a proximity to reward alert message 902. The alert message 902 may include alert trigger and criteria information. In some example embodiments, the alert trigger information may include alert triggers defined by the user (e.g., the proximity 902a and the merchant or merchant type 902b). Example embodiments may further include alert triggers that may be defined or otherwise derived from information provided by the merchant. For example, a distance remaining 902f may be derived, in part, from the condition precedent defined by the merchant. Although not shown, the alert message may provide or otherwise indicate a date by which the user must make a purchase to qualify for the reward, which can be derived from the alert trigger submitted by the merchant or issuer.

The alert message 902 may also show aggregated transaction data, such as the number of purchases 902e, a range of dates for the transactions 902c, and a total amount spent 902d. Because the intelligent notification engine does not use the accumulated amount spent 902d to determine whether a transaction qualifies as a triggering event, alert message 902 includes further aggregated transaction data, similar to the alert messages described above.

Multiple Users Associated with a User Account

In various embodiments, multiple users or multiple portable consumer devices can be associated with a particular user account. For example, many credit card accounts allow issuers to issue multiple credit cards to multiple users. In such cases, each credit card or user can have a unique identifier or sequence number to identify which credit card was used or which user initiated any particular credit card transaction. The unique identifiers can then be used to define alert messages and alert criteria, such as the alert messages and alert criteria discussed above, for each individual user or portable consumer device.

In some embodiments, a business or a household may have multiple portable consumer devices, each associated with a single financial account. However, each individual portable consumer device can contain a unique identifier. The intelligent notification engine 230 or other system can determine which individual portable consumer device for a certain account has been used, and can customize alert message and alert criteria based upon this information. This allows a family or business to set up reports for individual family members or individual employees. For example, a business may only authorize company credit cards to be used for payments for gasoline and airline tickets and, as a result, may wish to monitor the spending thereon. A message can be sent to the business any time a company credit card is used for such purposes and exceeds the company's estimated monthly budget for those purposes. The message can include an identifier for the individual portable consumer device, so that the business will know which employees were conducting the transactions. In another example, a message can be sent to the business regarding a transaction currently being conducted, and can include the portable consumer device identifier. In yet another example, the business may provide sub-budgets for expenditures for specific employees. For example, in a construction company, an electrician may have a smaller portion of the budget for tools, while the equipment manager may have a substantially larger portion.

In some embodiments, a business may create a policy for its employees to first submit virtual transactions a week in advance of making the purchases. The business may then receive an alert message if the weekly requests exceed the estimated budget. Otherwise, the virtual transactions may automatically be approved. Consequently, embodiments of the current invention may facilitate efficient communication among one or more people linked to a financial account.

An advantage of various embodiments of the present invention is realized in systems which compare and aggregate transaction data from an observed transaction with the prior transaction data to determine whether an alert message should be sent without the account holder, or possibly even the issuer, deciding when and how an alert message is generated. This frees up the account holder or the issuer from having to decide on a vast number of possibilities in conditions that would trigger an alert message. It also frees up the account holder from repeatedly accessing his or her account to determine if some event of interest has occurred. In this way, the alert messages provide relevant information at a relevant time.

Computer Systems

Any of the elements in FIG. 1-4 can use any suitable number of subsystems to facilitate the functions described herein. System 1000 in FIG. 10 is representative of a computer system capable of embodying various aspects of the present invention. The computer system can be present in any of the elements in FIG. 1-4, including notification engine 107, IP gateway 110, etc. Similarly, the various participants, entities and elements in FIG. 1 may operate one or more computer apparatuses to facilitate the functions described herein. It will be readily apparent to one of ordinary skill in the art that many other hardware and software configurations are suitable for use with the present invention.

For example, the computer may be a desktop, portable, rack-mounted or tablet configuration. Additionally, the computer may be a series of networked computers. Further, the use of other micro processors are contemplated, such as Xeon™, Pentium™ or Core™ microprocessors; Turion™ 64, Opteron™ or Athlon™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board. Various embodiments may be based upon systems provided by daVinci, Pandora, Silicon Color, or other vendors.

In one embodiment, computer system 1000 typically includes a display 1010, computer 1020, a keyboard 1030, a user input device 1040, computer interfaces 1050, and the like. In various embodiments, display (monitor) 1010 may be embodied as a CRT display, an LCD display, a plasma display, a direct-projection or rear-projection DLP, a microdisplay, or the like. In various embodiments, display 1010 may be used to display user interfaces and rendered images.

In various embodiments, user input device 1040 is typically embodied as a computer mouse, a trackball, a track pad, a joystick, wireless remote, drawing tablet, voice command system, and the like. User input device 1040 typically allows a user to select objects, icons, text and the like that appear on the display 1010 via a command such as a click of a button or the like. An additional specialized user input device 1045, such a magnetic stripe, RFID transceiver or smart card reader may also be provided in various embodiments. In other embodiments, user input device 1045 include additional computer system displays (e.g. multiple monitors). Further user input device 1045 may be implemented as one or more graphical user interfaces on such a display.

Embodiments of computer interfaces 1050 typically include an Ethernet card, a modem (telephone, satellite, cable, ISDN), (asynchronous) digital subscriber line (DSL) unit, FireWire interface, USB interface, and the like. For example, computer interfaces 1050 may be coupled to a computer network, to a FireWire bus, or the like. In other embodiments, computer interfaces 1050 may be physically integrated on the motherboard of computer 1020, may be a software program, such as soft DSL, or the like.

RAM 1070 and disk drive 1080 are examples of computer-readable tangible media configured to store data such user, account and transaction level data, calculated aggregated data, super keys, sub keys and other executable computer code, human readable code, or the like. Other types of tangible media include magnetic storage media such as floppy disks, networked hard disks, or removable hard disks; optical storage media such as CD-ROMS, DVDs, holographic memories, or bar codes; semiconductor media such as flash memories, read-only-memories (ROMS); battery-backed volatile memories; networked storage devices, and the like.

In the present embodiment, computer system 1000 may also include software that enables communications over a network such as the HTTP, TCP/IP, RTP/RTSP protocols, and the like. In alternative embodiments of the present invention, other communications software and transfer protocols may also be used, for example IPX, UDP or the like.

In various embodiments, computer 1020 typically includes familiar computer components such as a processor 1060, and memory storage devices, such as a random access memory (RAM) 1070, disk drives 1080, and system bus 1090 interconnecting the above components.

In some embodiments, computer 1020 includes one or more Xeon microprocessors from Intel. Further, in the present embodiment, computer 1020 typically includes a UNIX-based operating system.

It should be understood that embodiments of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a non-transitory computer readable medium, such as a random access memory (RAM), a read only memory (ROM), a magnetic medium such as a hard-drive or a floppy disk, or an optical medium such as a CD-ROM.

Any such non-transitory computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. For example, any of the above described alert triggers may be combined with any other suitable alert trigger in any suitable manner in methods or systems according to embodiments of the invention. As an illustration, a consumer may specify that he or she would like reports with specific sounds or ringtones, alert triggers, and aggregated transaction data, but not other types of reports. Thus, although specific features are separately described in this application, they may be combined in certain embodiments of the invention.

A recitation of “a”, “an” or “the” is intended to mean “one or more” unless specifically indicated to the contrary.

What is claimed is:

1. An alerts messaging system comprising:
a database comprising an alert trigger including information based on alert criteria from a user;
a server computer coupled to the database, wherein the server computer comprises a processor and a computer-readable storage medium coupled to the processor, the computer readable storage medium comprising code executable by the processor for implementing a method comprising:
receiving transaction data for transactions;
accessing the database comprising the alert trigger, including aggregating the transaction data that is associated with the alert criteria;
determining, using a server computer, if the alert trigger is met;
generating an alert message if the alert trigger is met, wherein the alert message includes the aggregated transaction data associated with the alert criteria;
not generating an alert message if the alert trigger is not met; and
sending the alert message to the user if the alert message was generated.

2. The system of claim 1, wherein the computer readable storage medium comprising the code executable by the processor for implementing the method further comprising aggregating additional transaction data that is not associated with the alert criteria, and wherein the alert message further includes the additional aggregated transaction data.

3. The system of claim 1, wherein the alert criteria includes one or more of: a transaction amount, a number of transactions, and a proximity to a reward.

4. The system of claim 1, wherein the alert criteria includes one or more of: a merchant, a merchant type and a time period.

5. The system of claim 1, wherein the aggregated transaction data comprises one or more of: a total number of transactions and a total amount of the transactions.

6. The system of claim 1, wherein at least one of the transactions is a virtual transaction.

7. The system of claim 6, wherein the virtual transaction corresponds to the user placing an item in a cart.

8. The system of claim 6, wherein the virtual transaction is submitted by the user via a web access.

9. The system of claim 1, wherein the alert criteria includes criteria from a merchant, issuer, or acquirer.

10. A method comprising:
receiving transaction data for transactions;
accessing a database comprising an alert trigger, including aggregating the transaction data that is associated with an alert criteria from a user;
determining, using a server computer, if the alert trigger is met;
generating an alert message if the alert trigger is met, wherein the alert message includes the aggregated transaction data associated with the alert criteria;
not generating an alert message if the alert trigger is not met; and
sending the alert message to the user if the alert message was generated.

11. The method of claim 10, further comprising:
aggregating additional transaction data that is not associated with the alert criteria, and wherein the alert message further includes the additional aggregated transaction data.

12. The method of claim 10, wherein the alert criteria includes one or more of: a transaction amount, a number of transactions, and a proximity to a reward.

13. The method of claim 10, wherein the alert criteria includes one or more of: a merchant, a merchant type, and a time period.

14. The method of claim 10, wherein the aggregated data comprises one or more of: a total number of transactions and a total amount of the transactions.

15. The system of claim 10, wherein at least one of the transactions is a virtual transaction.

16. The method of claim 15, wherein the virtual transaction corresponds to the user placing an item in a cart.

17. The method of claim 15, wherein the virtual transaction is submitted by the user via a web access.

18. The system of claim 1, wherein the alert criteria includes criteria from a merchant, issuer, or acquirer.

19. The system of claim 18, wherein the criteria from a merchant, issuer, or acquirer is associated with a reward.

20. A computer readable medium storing commands for causing a processor to implement the method of claim 10.
